(19) United States
(12) Patent Application Publication
(10) Pub. No.: US 2018/0005315 A1
(43) Pub. Date: Jan. 4, 2018

(54) SYSTEMS AND METHODS FOR DETECTING AND MONITORING SUSPICIOUS SYSTEM ACTIVITY

(71) Applicant: Viewpost IP Holdings, LLC, Maitland, FL (US)

(72) Inventor: Jennifer Rae Rines, Maitland, FL (US)

(21) Appl. No.: 15/199,628

(22) Filed: Jun. 30, 2016

(51) Int. Cl. G06Q 40/02; G06Q 30/00

(52) U.S. Cl. CPC G06Q 40/02; G06Q 30/0185; H04L 2463/102

(57) ABSTRACT

Systems and methods are provided for receiving a plurality of categories of data, each category comprising at least one subcategory, receiving a weight associated with each subcategory, and storing the plurality of categories, associated subcategories and the weight associated with each subcategory. The systems and methods further provide for determining that an activity occurring in a system has triggered a risk analysis, compiling data related to a user associated with the activity, analyzing the data related to the user and determining one or more subcategories for the data, determining a risk rating for the user based on the weight of each of the one or more subcategories, comparing the risk rating to one or more predetermined threshold values to determine an alert value for the user, and storing the risk rating for the user, the alert value for the user, and the data related to the user.

### BACKGROUND

Financial crimes, such as money laundering and terrorist financing, are increasingly difficult to detect and monitor because of the various methods available to conduct financial transactions via computers and the Internet. As new methods are used to commit financial crimes via computing technology and the Internet, new methods for risk analysis are needed to detect and monitor suspicious activity.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments, configured to detect and monitor suspicious system activity.

FIG. 2 is a block diagram illustrating aspects of a server, according to some example embodiments.

FIG. 3 is a flowchart illustrating aspects of a method, according to some example embodiments, for receiving and storing categories of data.

FIG. 4 is a flowchart illustrating aspects of a method, according to some example embodiments, for performing risk analysis.

FIGS. 5A-5B illustrate example categories and subcategories, according to some example embodiments.

FIG. 6 illustrates example weights, ratings, and actions, according to some example embodiments.

FIG. 7A-7F illustrate example interfaces, according to some example embodiments.

FIG. 8 is a block diagram illustrating an example of a software architecture that may be installed on a machine, according to some example embodiments, configured to perform risk analysis.

FIG. 9 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to detecting and monitoring suspicious system activity. In one embodiment, a server computer receives a plurality of categories of data, each category comprising at least one subcategory. The server computer further receives a weight associated with each subcategory, and stores the plurality of categories, associated subcategories, and the weight associated with each subcategory. The server computer determines that an activity occurring in a system has triggered a risk analysis. The server computer compiles data related to a user associated with the activity, analyzes the data related to the user and determines one or more subcategories for the data. The server computer further determines a risk rating for the user based on the weight of each of the one or more subcategories, compares the risk rating to one or more predetermined threshold values to determine an alert value for the user, and stores the risk rating for the user, the alert value for the user, and the data related to the user.

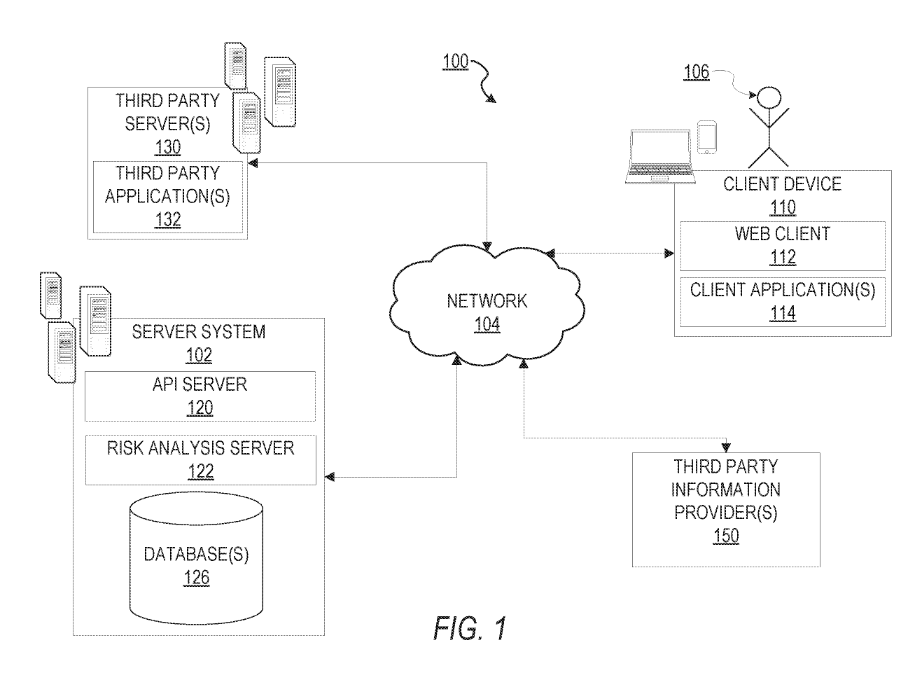

FIG. 1 is a block diagram illustrating a networked system 100, according to some example embodiments, configured to detect and monitor suspicious system activity (e.g., perform risk analysis). The system 100 may include one or more client devices such as client device 110. The client device 110 may comprise, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, computers in vehicles, or any other communication device that a user may utilize to access the networked system 100. In some embodiments, the client device 110 may comprise a display module (not shown) to display information (e.g., in the form of user interfaces). In further embodiments, the client device 110 may comprise one or more of touch screens, accelerometers, gyroscopes, cameras, microphones, global positioning system (GPS) devices, and so forth.

The client device 110 may be a device of a user that is used to conduct and monitor financial transactions, such as sending and receiving invoices, making and receiving payment transactions, reviewing the status of invoices and payments, and so forth. The client device 110 may be a device of a user that is used to request and review risk analysis and related information. In one embodiment, the system 100 is a risk analysis system to analyze user-related data from a plurality of sources to determine a risk rating and further actions associated with the risk rating.

One or more users 106 may be a person, a machine, or other means of interacting with the client device 110. A user 106 may refer to an individual or an entity, such as a business. In example embodiments, the user 106 may not be part of the system 100, but may interact with the system 100 via the client device 110 or other means. For instance, the user 106 may provide input (e.g., touch screen input or alphanumeric input) to the client device 110 and the input may be communicated to other entities in the system 100 (e.g., third party servers 130, server system 102, etc.) via the network 104. In this instance, the other entities in the system 100, in response to receiving the input from the user 106, may communicate information to the client device 110 via the network 104 to be presented to the user 106. In this way, the user 106 may interact with the various entities in the system 100 using the client device 110.

The system 100 may further include a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 110 may access the various data and applications provided by other entities in the system 100 via web client 112 (e.g., a browser, such as the Internet Explorer® browser developed by Microsoft® Corporation of Redmond, Wash. State) or one or more client applications 114. The client device 110 may include the one or more client applications 114 (also referred to as “apps”) such as, but not limited to, a web browser, messaging application, electronic mail (email) application, an e-commerce site application, an invoicing and electronic payments application, a banking application, and the like. In some embodiments, one or more client applications 114 may be included in a given one of the client device 110, and configured to locally provide the user interface and at least some of the functionalities with the client application 114 configured to communicate with other entities in the system 100 (e.g., third party servers 130, server system 102, etc.), on an as needed basis, for data and/or processing capabilities not locally available (e.g., access to invoice or payment information, to authenticate a user 106, to verify a method of payment, etc.). Conversely, one or more client applications 114 may not be included in the client device 110, and then the client device 110 may use its web browser to access the one or more applications hosted on other entities in the system 100 (e.g., third party server(s) 130, server system 102, etc.).

A server system 102 may provide server-side functionality via the network 104 (e.g., the Internet or wide area network (WAN)) to one or more third party servers 130 and/or one or more client devices 110. The server system 102 may be a cloud computing environment, according to some example embodiments. The server system 102 may include an application program interface (API) server 120 and a risk analysis server 122. The Am server 120 and risk analysis server 122 may be communicatively coupled with one or more databases 126. The database(s) 126 may be storage devices that store information such as categories of data, subcategories of data, weights associated with subcategories of data, ratings associated with subcategories of data, actions associated with subcategories of data, data related to one or more users, risk analysis, etc. The API server 120 may provide functionality to support interfacing with external entities and internal applications and servers.

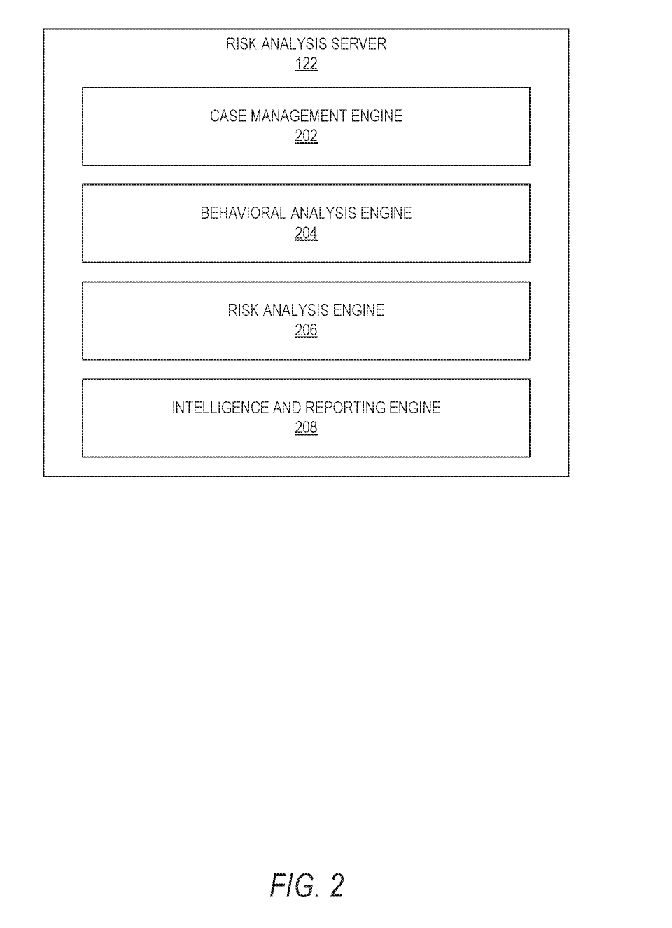

The risk analysis server 122 may provide functionality to perform risk analysis and related calculations, reporting of risk analysis, and so forth. The risk analysis server 122 may access one or more databases 126 to retrieve stored data to use in calculations and analysis and to store results of calculations and analysis. The risk analysis server 122 may include one or more modules or engines, as shown in FIG. 2. The example risk analysis server 122 of FIG. 2 shows several different engines associated with different functionality. It is understood that all of the functionality could be in one module or engine, some functionality may span across several engines or servers, and so forth.

A case management engine 202 may provide functionality managing cases resulting from risk analysis or related functions. For example, the case management engine 202 may provide a dashboard or one or more user interfaces for one or more users to search, view, track, edit, and manage cases in the risk analysis system.

A behavioral analysis engine 204 may provide functionality to generate user profile data and analyze user behavior. For example, the behavioral analysis engine 204 may analyze user historical data for patterns, to determine deviations from normal patterns, predictive analytics, etc. For instance, a user (e.g., company A) may typically make a large payment to Santa Company in November every year to hire a Santa for each of its stores; or a user (e.g., Company B) may historically operate only in China, then open a new office in Europe, and suddenly a lot of activity (e.g., payments, invoices, correspondence via IP addresses in Europe), etc. is occurring in Europe; or a user (e.g., Company C) may historically interact with a first type of company (e.g., supplier of children's clothing) and buy a company that specializes in jewelry; or a user may typically only conduct payment transactions between its business hours of 9:00 am and 5:00 pm and one day start conducting large payment transactions at midnight, and so forth. The behavioral analysis engine 204 may be able to generate user profile data and provide alerts when there is a change in behavior of a user (e.g., new business partner, larger or smaller than normal payment transaction, transactions outside of normal business hours, risk rating increase in business partner, change in address, change in bank, change in geographic location or business dealings, etc.). Changes in behavior may also trigger a risk analysis, as described below. User data may be continuously updated, and thus user profile data may be continuously updated and analyzed.

A risk analysis engine 206 may provide functionality for risk analysis and related calculations. For example, the risk analysis engine 206 may receive and store categories of data, subcategories of data, a weight associated with each subcategory of data, a rating associated with each subcategory of data, a response action associated with each subcategory of data, and so forth. The risk analysis engine 206 may determine that an activity occurred or is occurring in a system that triggers a risk analysis, determine a user associated with the activity, and compile data related to the user associated with the activity. The risk analysis engine 206 may analyze the data related to the user to determine a risk rating and determine whether the risk rating triggers an alert based on one or more predetermined threshold values. The risk analysis engine 206 may store the risk rating, alert value, data, calculations, etc., to one or more databases 126.

An intelligence and reporting engine 208 may provide functionality to provide output of risk analysis. For example, the intelligence and reporting engine 208 may provide results and reports of risk analysis, generate and provide alerts related to results of risk analysis, and so forth.

Returning to FIG. 1, the system 100 may further include one or more third party servers 130. The one or more third party servers 130 may include one or more third party application(s) 132. The one or more third party application(s) 132, executing on third party server(s) 130, may interact with the server system 102 via API server 120 via a programmatic interface provided by the API server 120. For example, one or more of the third party application(s) 132 may request and utilize information from the server system 102 via the API server 120 to support one or more features or functions on a website hosted by the third party or an application hosted by the third party. The third party server(s) 130 may request risk analysis results and related data that are supported by relevant functionality and data in the server system 102.

The system 100 may further include one or more third party information provider(s) 150. The third party information provider(s) 150 may include data sources such as Dun and Bradstreet, Secretary of State, Google DMV, public state/government records, Department of Treasury, property records, credit bureau(s), yellow pages, open source public data, LexisNexis, privacy data, fraud data, vendor assurance data, cybersecurity data, payment data, and so forth. The server system 102 may interact with third party information provider(s) 150 to request and receive data via the network 104. For example, the risk analysis server 122 may request and receive data related to a particular user (e.g., individual or company) such as high-value assets (e.g., amount, type), access to funds, geographic risk, business validity, business stability, type of industry, risk of industry, business shell or shelf, business structure type, business age range, business match level, business legal activity, business news profile, business news profile type, linked businesses, executive officer data, criminal activity, driving record, verification data (e.g., for address, phone number, company name, individual name, etc.) tickets and fines, and so forth.

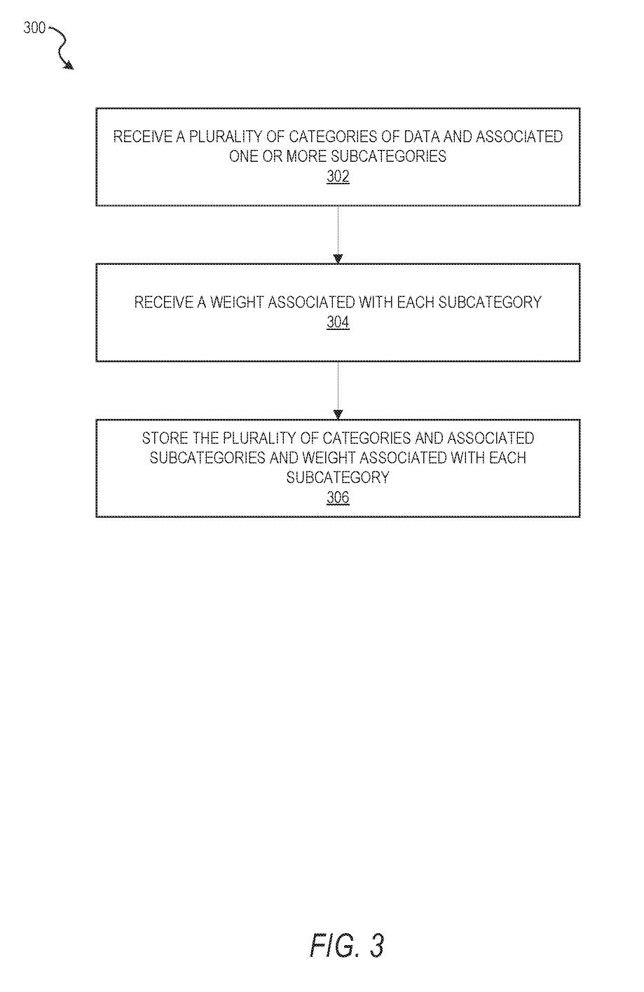

FIG. 3 is a flow chart illustrating aspects of a method 300, according to some example embodiments, for receiving and storing categories of data. For illustrative purposes, method 300 is described with respect to the networked system 100 of FIG. 1 and the risk analysis server 122 diagram of FIG. 2. It is to be understood that method 300 may be practiced with other system configurations in other embodiments.

In operation 302, the risk analysis server 122 (e.g., via risk analysis engine 206) receives a plurality of categories of data. For example, various user data may be categorized into a plurality of categories. Each category of the plurality of categories may comprise at least one subcategory. Data from third party information provider(s) 150 or internal sources (e.g., user system activity, user profile data, user behavioral data, etc.), may be categorized into one or more categories with each categories having one or more subcategories. In one example, categories may be entered by a user via a client device 110 and sent from the client device 110 to the risk analysis server 122, or may be sent by a third party information provider 150, for example, via a client device or server machine. Categories and subcategories may be updated or added at any time.

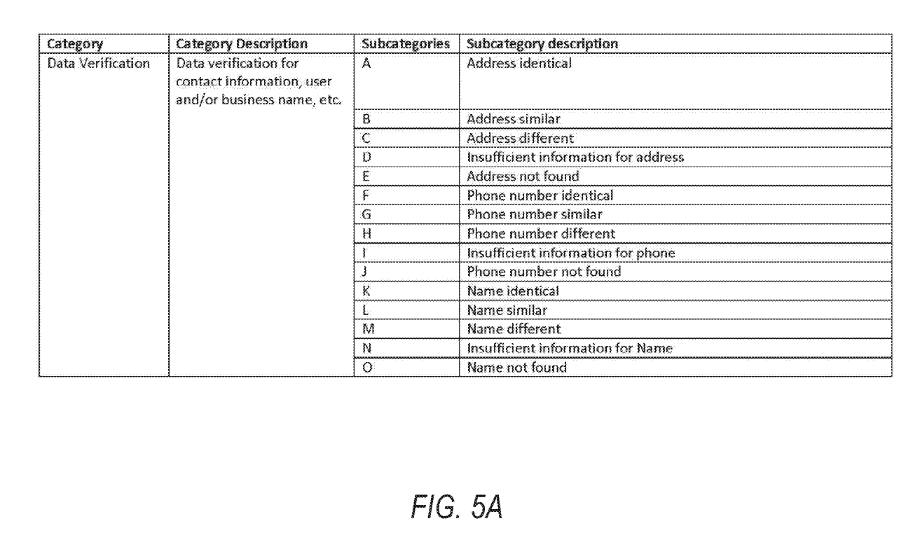

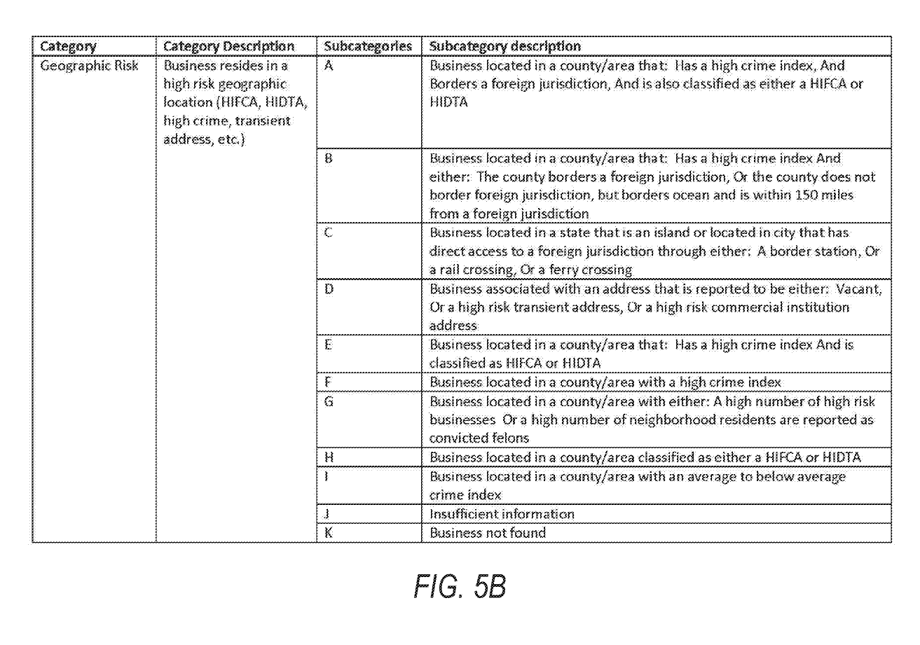

Example categories and subcategories are shown in FIGS. 5A and 5B. The example in FIG. 5A shows a data verification category for verifying user contact information, business name, etc. The data verification category has a number of subcategories A-O. For example, an address may be compared against third party information provider(s) 150 data, internal data, and so forth. Subcategory A indicates that the address appears as identical when compared to these one or more sources. Subcategory B indicates the address is similar, subcategory C indicates the address is different, subcategory D indicates that there is insufficient information for the address verification, subcategory E indicates the address is not found, and so forth.

The example in FIG. 5B shows a geographic risk category indicating whether the business is located in a high-risk geographic location. For example, subcategory A indicates that the business is located in a country/area that has a high crime index and borders a foreign jurisdiction, and is also classified as HIFCA (High Intensity Financial Crime Area) or HIDTA (High Intensity Drug Trafficking Area), subcategory B indicates that the business is located in a country/area that has a high crime index and borders a foreign jurisdiction, or does not border a foreign jurisdiction but borders an ocean and is within 150 miles from a foreign jurisdiction, and so forth.

FIGS. 5A and 5B show examples of categories and subcategories. Other category examples may include an amount of high-value assets the user or business owns, a type of high-value assets, access to funds, geographic risk, business validity, business stability, type of industry, risk of industry, business s ell or shelf, business structure type, business age range (e.g., based on Secretary of State incorporation date age range, based on public record age range, etc.), business match level, business legal activity, business news profile, business news profile type, linked businesses, executive officer data (e,g., executive office risk of money laundering, executive officer residency risk (e.g., immigrants, non-US citizens, ties outside the U.S., etc.)), Dun and Bradstreet data, driving record data, criminal activity data, privacy data, fraud data, vendor assurance data, cybersecurity data, payment data, and so forth.

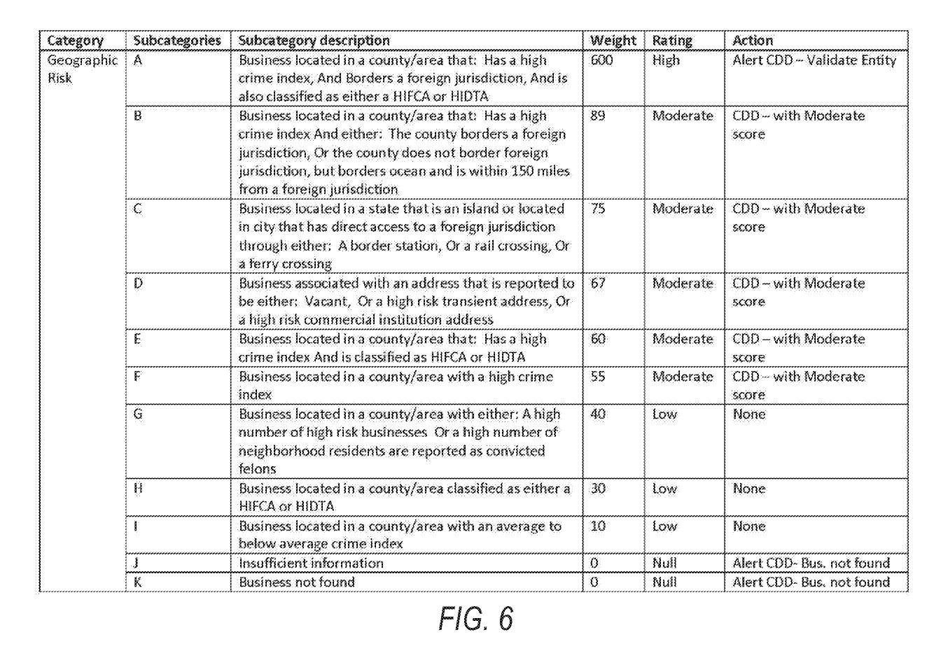

Returning to FIG. 3, at operation 304 the risk analysis server 22 receives a weight associated with each subcategory. For example, some subcategories may be deemed more important than other subcategories. In a criminal activity category, for instance, committing a felony may be weighted higher than a parking ticket. In one example, each subcategory may be weighted between 0 and 1000. The table in FIG. 6 shows one example of how various subcategories within a category may be weighted. In this example, subcategory A is weighted the highest because it was deemed that a business located in a county/area that has a high crime index, etc., would be a higher risk than, for example, a business located in a county/area with an average to below-average crime index (e.g., subcategory I). In one example, weights may be entered by a user via a client device 110 and sent from the client device 110 to the risk analysis server 122.

The risk analysis server 122 may also receive a rating for each subcategory and a response action for each subcategory. For example, subcategory A in FIG. 6 may have a rating of “high” and a response action indicating that an alert should be sent to perform customer due diligence (CDD) and validate the entity. In one example, ratings may be entered by a user via a client device 110 and sent from the client device 110 to the risk analysis server 122. Weights, ratings, and actions may be adjusted or updated at any time.

Returning to FIG. 3, at operation 306 the risk analysis server 122 stores the plurality of categories and associated subcategories and the weight associated with each subcategory. In addition, the risk analysis server 122 may store any rating associated with a subcategory or action associated with a subcategory. For example, the risk analysis server 122 may store the weight, rating, and action in one or more databases 126. This data may be used to perform risk calculations and related analysis, as described next.

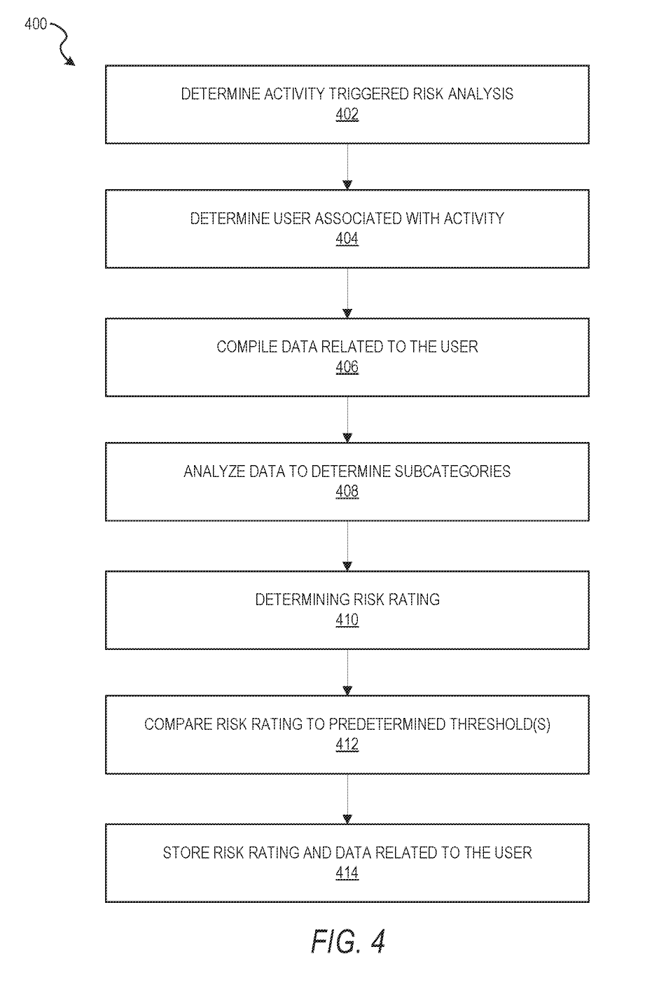

FIG. 4 is a flow chart illustrating aspects of a method 400, according to some example embodiments, for performing risk analysis. For illustrative purposes, method 400 is described with respect to the networked system 100 of FIG. 1 and the risk analysis server diagram of FIG. 2. It is to be understood that method 400 may be practiced with other system configurations in other embodiments.

In operation 402, the risk analysis server 122 (e.g., via risk analysis engine 206) determines that an activity occurring in the system has triggered a risk analysis. There may be several types of activities that trigger a risk analysis. Some example types of activities that may trigger a risk analysis include receiving a registration request from a user, a change in a company name associated with a user, a new account added by a user, a change in address associated with a user, a transaction amount over a predetermined threshold, and an addition of a new user associated with a user. In another example, a trigger may be a predetermined date and/or time that a risk analysis is to be run (e.g., every month, every quarter, every few days, etc.) for a particular user or group of users (e.g., different categories of users based on risk rating, type of industry, etc.). In yet another example, the trigger may be a manual request by an agent to run a risk analysis on a particular user.

In one example, the server system 102 may be an invoicing and electronic payments system. A user may use a client device 110 to access a website (e.g., via web client 112) or a client application 114 associated with the system to register with the system. For example he may enter his name, address, contact information (e.g., address, phone number, etc.) and company name. The user may submit the request for registration, which will be sent by the client device 110 to the server system 102. The server system 102 may receive the request for registration, which will automatically trigger a risk analysis to be performed (e.g., by risk analysis server 122).

At operation 404, the risk analysis server 122 determines a user associated with the activity (e.g., the registration request, the new account added, etc.). For example, the risk analysis server 122 may determine the user based on the information provided in a registration request (e,g., the user name or company name), based on information included in a transaction request message or transaction history (e.g., for a transaction over a predetermined amount or a transaction with a new business, etc.), and so forth.

The risk analysis server 122 compiles data associated with the user at operation 406. For example, the risk analysis server 122 may look up user profile data, behavioral information, past risk analysis results, and other data in one or more databases 126. In addition, or in the alternative, the risk analysis server 122 may request data associated with the user from one or more third party information provider 150. The risk analysis server 122 may store all the compiled data associated with the user in one or more databases 126. Data associated with a user may include an amount of high-value assets, a type of high-value assets, access to funds, geographic risk, business validity, business stability, type of industry, risk of industry, business shell or shelf, business structure type, business age range, business match level, business legal activity, business news profile, business news profile type, linked businesses, executive officer data, contact information, criminal activity, driving records, credit scores, user profile data, behavioral information, past risk analysis results, privacy data, fraud data, vendor assurance data, cybersecurity data, payment data, and so forth.

In one example the risk analysis server 122 may send a request for data related to the user to one or more third party information providers 150. In one example the request may include the name of the user (e.g., individual name, business name, etc.) and any contact information for the user (e.g., individual address, phone number, email address, etc., or business address, phone number, email address, etc.). The request may also include an employer identification number (EIN) or taxpayer identification number (TIN), etc., or other identifying information or other data. The risk analysis server 122 may receive a response from the one or more third party information providers 150, with third party data related to the users. The risk analysis server 122 may access internal data related to the user from one or more databases 126 and combine the third party data and internal data to form the compiled data.

At operation 408, the risk analysis server 122 analyzes the compiled data associated with the user to determine subcategories associated with the compiled data. For example, the risk analysis server 122 may determine that the subcategories associated with the compiled data include a first subcategory of a first category (e.g., data verification subcategory B), a second subcategory of the first category (e.g., data verification subcategory F), a third subcategory of the first category (e.g., data verification subcategory L), a first subcategory of a second category (e.g., geographic risk subcategory A), a first subcategory of a third category (e.g., business industry risk subcategory G), and so forth.

At operation 410, the risk analysis server 122 analyzes the one or more subcategories associated with the compiled user data to determine the risk rating for the user. The risk rating for the user may be based on the weight of each of the one or more subcategories. For example, the risk analysis server 122 may calculate the total amount of all of the weights associated with each of the one or more subcategories associated with the compiled data. Using a simple example, there may be three subcategories associated with the compiled data. The first subcategory may have a weight of 600, the second subcategory may have a weight of 50, and the third subcategory may have a weight of 0. The risk rating in this example would be 650 (e.g., 600+50+0).

The risk analysis server 122 compares the risk rating to one or more predetermined threshold values to determine an alert value for the user, in operation 412. For example, there may be various levels of alert value. In one example the alert levels could be green (low risk), orange (moderate risk), red (high risk), black (denied/close account). In another example the alert levels could be low (low risk), moderate (moderate risk), high (high risk), close (close account). Each level of alert value may be associated with a threshold value or a range of threshold values. In one example, a low risk (e.g., green, low, etc.) may be a risk score between 0-200, a moderate risk (e.g., orange, moderate, etc.) may be a risk score between 201-400, a high risk (e.g., red, high, etc.) may be a risk score between 401-599, a close (e.g., black, denied/close account, etc.) may be a risk score between 600-1000.

At operation 414, the risk analysis server 122 stores the risk rating, the alert value, and the data related to the user. For example, the risk analysis server 122 may store the risk rating, alert value, user data, and any calculations and analysis, in one or more databases 126. The stored data may be used to automatically take action on an account associated with a user (e.g., close an account, request further information from a user, etc.) provide data and analysis to a user via a client device 110, provide alerts to a user via a client device 110, generate reports, etc.

For example, the risk analysis server 122 (e.g., via the intelligence and reporting engine 208) may provide the risk rating and the alert value to an agent or the user. In the example above, where the user risk rating was determined to be 650, the alert value for the user would be black or denied/close account. In this example, the risk analysis server 122 may automatically close (e.g., freeze, lock) the user account. The risk analysis server 122 may then generate an alert to be sent to an agent to conduct further research and/or to the user to indicate that the account has been closed. In the event that the risk analysis server 122 determines that the alert value is a low risk, no further action may be necessary since there is little to no risk of criminal or other malicious activity by the user. In the event the risk analysis server 122 determines that the alert value is moderate, an alert may be sent to an agent for further analysis or the user may be automatically monitored for suspicious activity. In the event the risk analysis server 122 determines that the alert value is high risk, an alert may be sent to an agent for immediate review to determine whether the account should be closed.

Other alerts may be provided to agents or users. For example, even though a user risk rating may be determined to be a low risk alert value, the risk analysis server 122 may still generate and provide an alert based on a specific category that rated high or where there was insufficient information. Using the example in FIG. 6, one of the subcategories associated with the compiled user data may be geographic risk category subcategory J for insufficient information. Even though the weight is low and an overall risk rating may be low enough to justify not taking further action, the risk analysis server 122 may generate and provide an alert to the user to request further information about their business (e.g., geographic location) or an alert to an agent to do further investigation about the business and/or follow up with the user. Or, if a risk rating is moderate or high, an additional alert may still go out to the user or agent to request further information, and so forth.

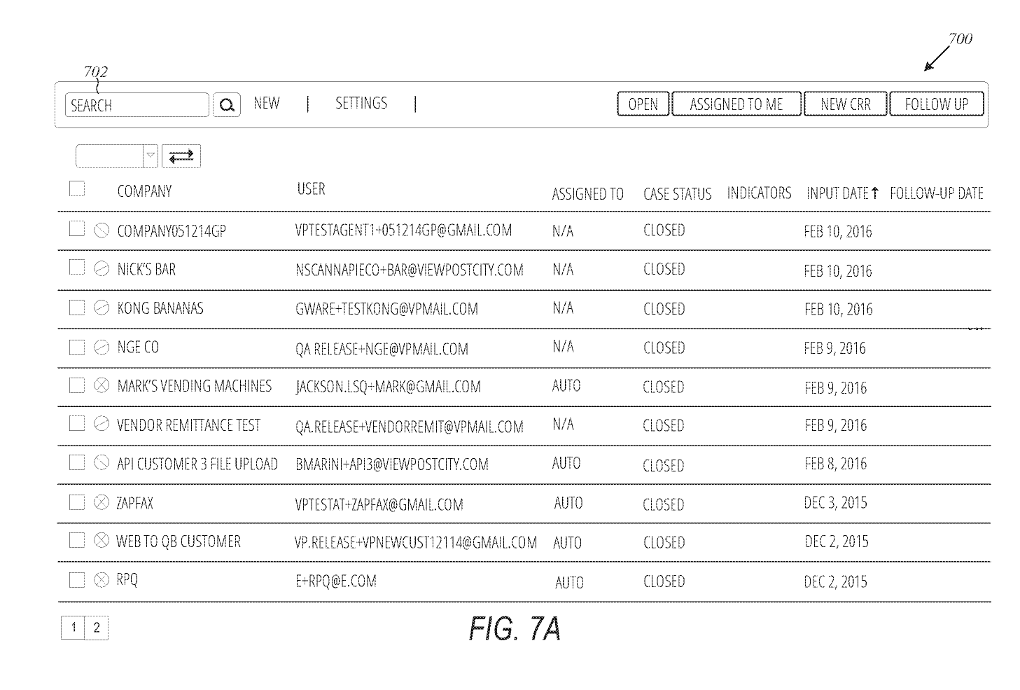

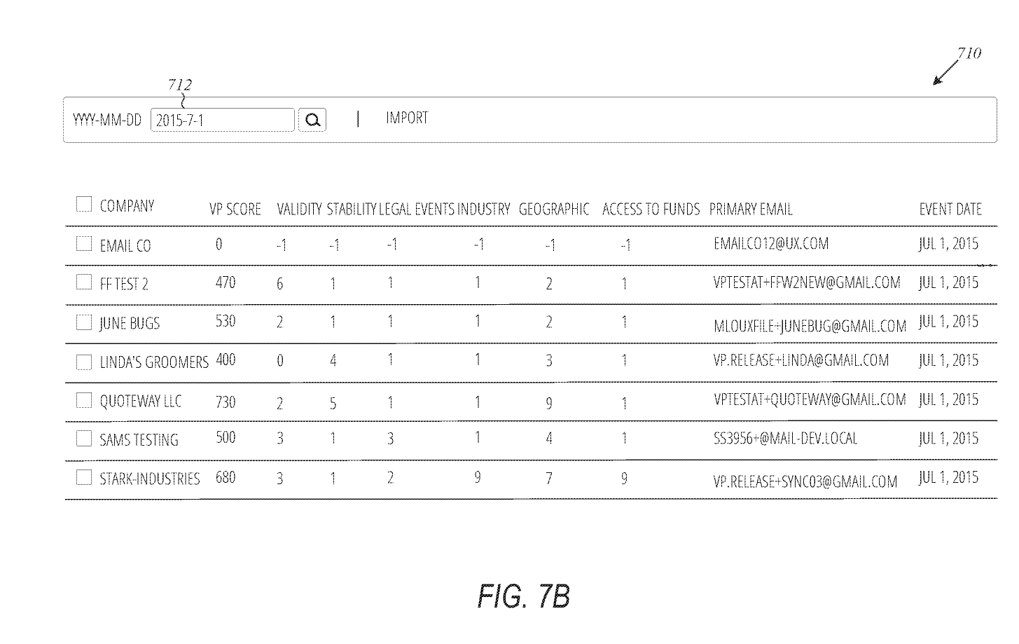

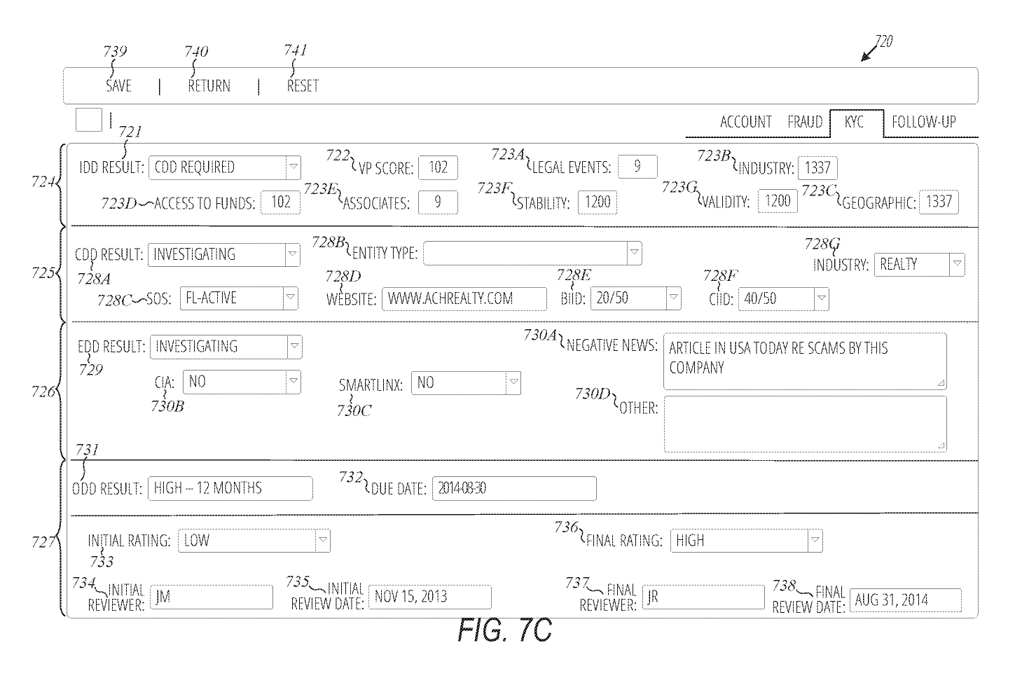

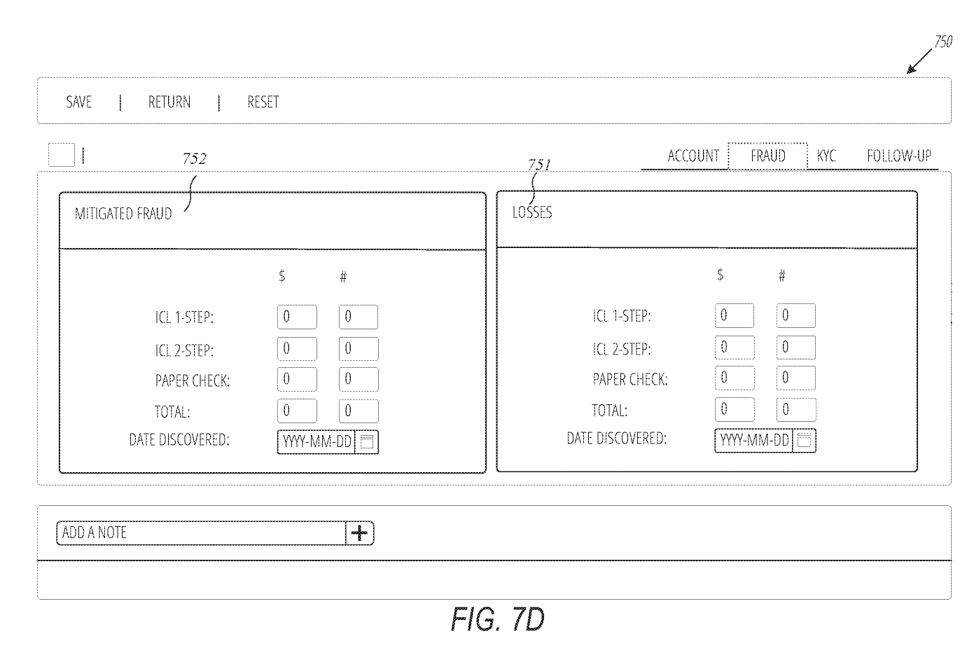

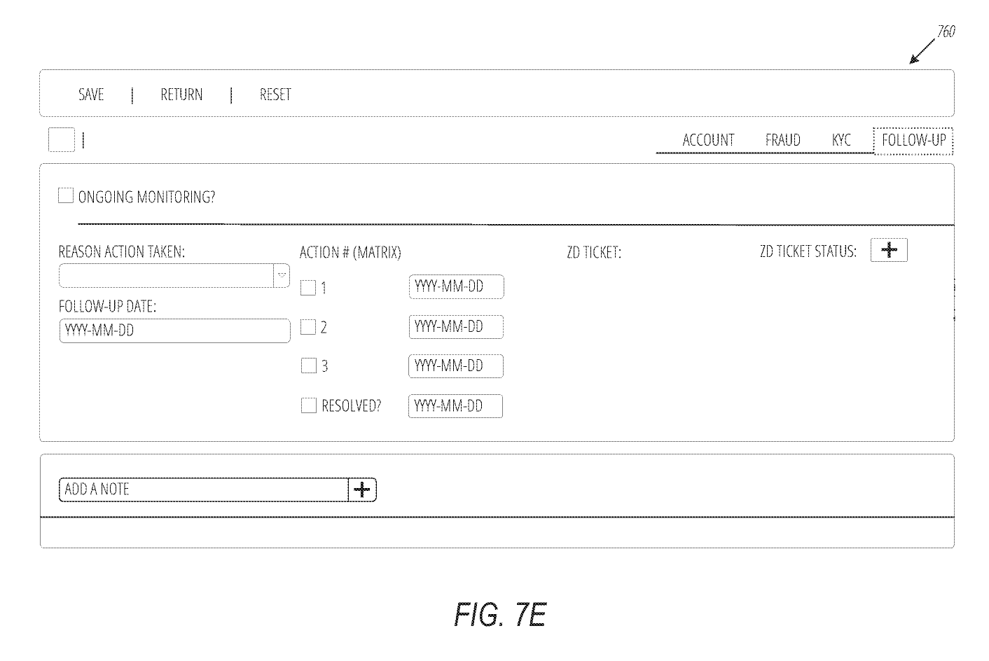

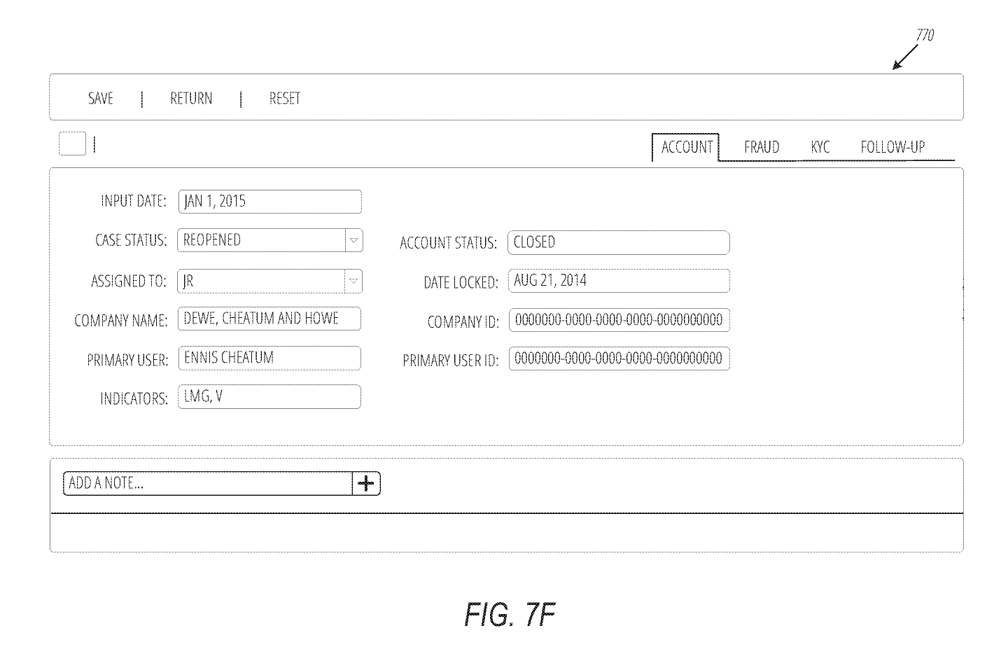

In one example, a user interface may be provided to allow a user (e.g., an agent or analyst) to receive and view alerts, view risk analysis results, search for specific users or specific risk analysis, review a particular case related to a user and edit or add additional information to the case, view reports, etc. Example user interfaces are shown in FIGS. 7A-7F.

FIG. 7A shows an example user interface 700 that allows a user to view a list of risk analysis cases. The interface 700 may show all of the pending cases, or the most recent cases (e.g., in last hour, 24 hours, etc.), the results of a search for a specified data range or particular user(s), etc. The interface 700 has a search input field 702 to allow a user to search for a particular user, a particular case, a date range of cases, etc. For example, the interface 710 in FIG. 7B shows the search results for a particular date 712 (e.g., Jul. 1, 2015).

FIG. 7C shows an example user interface 720 with details for a particular case. The user interface 720 shows the results for the initial due diligence (IDD) 724, the customer due diligence (CDD) 725, the enhanced due diligence 726 (EDD), and the ongoing due diligence (ODD) 727. For example, the IDD result 721 indicates that CDD is required. The risk rating (e.g., VP Score) 722 is 102 and the risk ratings for each relevant category are shown as reference numbers 723A-723G. The CDD result 728A indicates that the case is being investigated. Various other information may be shown such as entity type 728B, secretary of state information 7280, the entity website 728D, the Business Identification (BIID) 728E, the Consumer Identification (CIID) 728F and the industry 728G. The EDD result 729 indicates the case is being investigated and contains further information such as shown in reference numbers 730A-730D. The ODD result 731 indicates that the user is in a high risk category and that a risk analysis should be re-run every 12 months. Other information includes the ODD due date 732 for re-running the risk analysis, the initial risk rating 733 for the user, the initial reviewer 734, the initial review date 735, the final rating 736, the final reviewer 737, and the final review date 738. Any changes made to the case may be saved via the save menu item 739. The user or agent viewing or editing the user interface 720 may return to a previous screen via menu item 740, or reset the case via menu item 741.

FIG. 7D shows an example user interface 750 to show a reporting for any loss 751 taken for a case and any fraud mitigated 752. FIG. 7E shows an example user interface 760 to manage ongoing monitoring of a case. FIG. 7F shows an example user interface 770 for an overview or summary for a particular case.

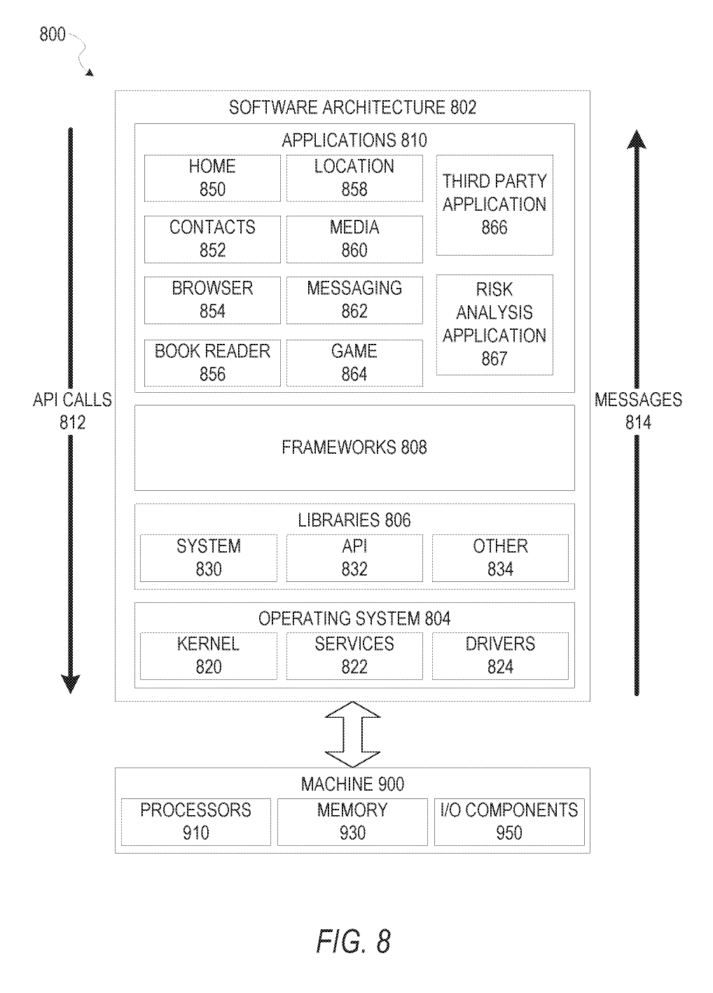

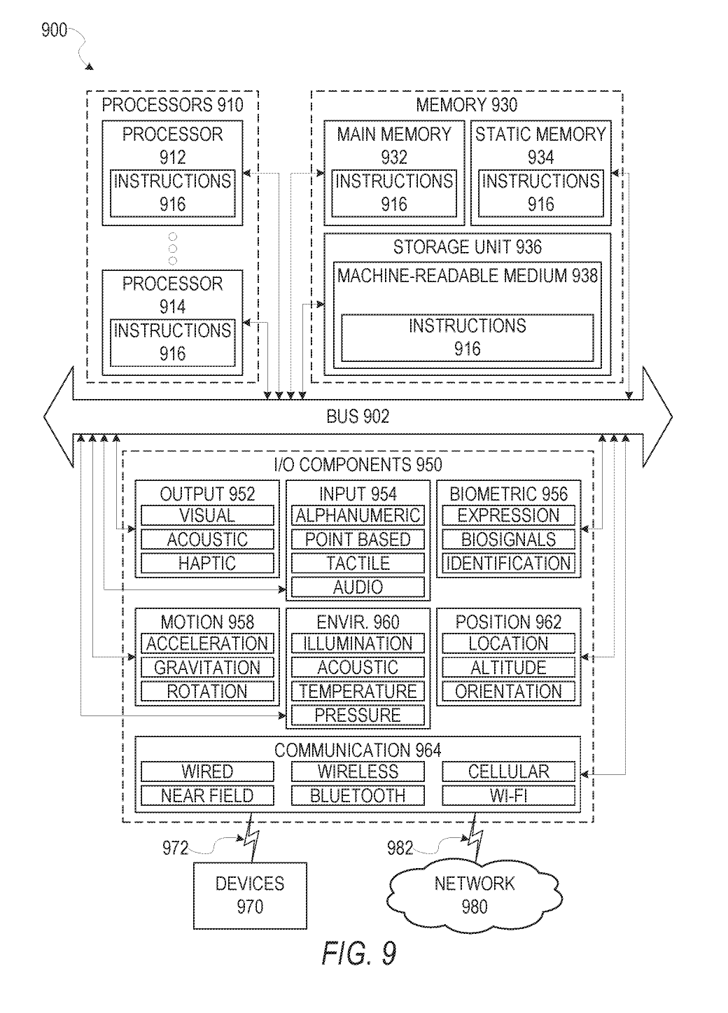

FIG. 8 is a block diagram 800 illustrating software architecture 802, which can be installed on any one or more of the devices described above. For example, in various embodiments, client devices 110, server system 102, and servers 120, 122, 130 may be implemented using some or all of the elements of software architecture 802. FIG. 8 is merely a non-limiting example of a software architecture, and it will be appreciated that many other architectures can be implemented to facilitate the functionality described herein. In various embodiments, the software architecture 802 is implemented by hardware such as machine 900 of FIG. 9 that includes processors 910, memory 930, and I/O components 950. In this example, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke application programming interface (API) calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4). Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and Three dimensions (3D) in graphic content on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various graphic user interface (GUI) functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application. 862, a game application 864, and a broad assortment of other applications such as a third party applications 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third party application 866 can invoke the API calls 812 provided by the operating system 804 to facilitate functionality described herein.

Some embodiments may particularly include a risk analysis application 867. In certain embodiments, this may be a stand-alone application that operates to manage communications with a server system such as third party server(s) 130 or server system 102. In other embodiments, this functionality may be integrated with another application. Risk analysis application 867 may request and display various types of risk analysis information and may provide the capability for a user to input data related to risk analysis and related user data via a touch interface, keyboard, or using a camera device of machine 900, communication with a server system via. I/O components 950, and receipt and storage of risk analysis and related user data in memory 930. Presentation of risk analysis information and user inputs associated with risk analysis information may be managed by risk analysis application 867 using different frameworks 808, library 806 elements, or operating system 804 elements operating on a machine 900.

FIG. 9 is a block diagram illustrating components of a machine 900, according to some embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application. 810, an applet, an app, or other executable code) for causing the machine 900 to perform any one or more of the methodologies discussed herein can be executed. In alternative embodiments, the machine 900 operates as a standalone device or can be coupled (e.g., networked) to other machines. In a networked deployment, the machine 900 may operate in the capacity of a server system 102, servers 120, 122, 130, etc., or a client device 110 in a server--client network environment, or as a peer machine in a peer-to-peer (or distributed) network environment. The machine 900 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

In various embodiments, the machine 900 comprises processors 910, memory 930, and I/O components 950, which can be configured to communicate with each other via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 912 and a processor 914 that may execute the instructions 916. The term “processor” is intended to include multi-core processors 910 that may comprise two or more independent processors 912, 914 (also referred to as “cores”) that can execute instructions 916 contemporaneously. Although FIG. 9 shows multiple processors 910, the machine 900 may include a single processor 910 with a single core, a single processor 910 with multiple cores (e.g., a multi-core processor 910), multiple processors 912, 914 with a single core, multiple processors 912, 914 with multiples cores, or any combination thereof.

The memory 930 comprises a main memory 932, a static memory 934, and a storage unit 936 accessible to the processors 910 via the bus 902, according to some embodiments. The storage unit 936 can include a machine-readable medium 938 on which are stored the instructions 916 embodying any one or more of the methodologies or functions described herein. The instructions 916 can also reside, completely or at least partially, within the main memory 932, within the static memory 934, within at least one of the processors 910 (e.g., within the processor's cache memory), or any suitable combination thereof, during execution thereof by the machine 900. Accordingly, in various embodiments, the main memory 932, the static memory 934, and the processors 910 are considered machine-readable media 938.

As used herein, the term “memory” refers to a machine-readable medium 938 able to store data temporarily or permanently and may be taken to include, but not be limited to, random-access memory (RAM), read-only memory (ROM), buffer memory, flash memory, and cache memory. While the machine-readable medium 938 is shown, in an example embodiment, to be a single medium, the term “machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 900), such that the instructions 916, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 include a wide variety of components to receive input, provide output, produce output, transmit information, exchange information, capture measurements, and so on. In general, it will be appreciated that the I/O components 950 can include many other components that are not shown in FIG. 9. The I/O components 950 are grouped according to functionality merely for simplifying the following discussion, and the grouping is in no way limiting various example embodiments, the I/O components 950 include output components 952 and input components 954. The output components 952 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 include alphanumeric input components (e,g., a keyboard, a touch screen configured to receive alphanumeric input, a photo-optical keyboard, or other alphanumeric input components), point-based input components (e.g., a mouse, a touchpad, trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 950 include biometric components 956, motion components 958, environmental components 960, or position components 962, among a wide array of other components. For example, the biometric components 956 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 include acceleration sensor components (e.g., accelerometer), gravitation sensor components, rotation sensor components (e.g., gyroscope), and so forth. The environmental components 960 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 962 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 950 may include communication components 964 operable to couple the machine 900 to a network 980 or devices 970 via a coupling 982 and a coupling 972, respectively. For example, the communication components 964 include a network interface component or another suitable device to interface with the network 980. In further examples, communication components 964 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 970 may be another machine 900 or any of a wide variety of peripheral devices (e.g., a peripheral device coupled via a Universal Serial Bus (USB)).

Moreover, in some embodiments, the communication components 964 detect identifiers or include components operable to detect identifiers. For example, the communication components 964 include radio frequency identification (REID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data. Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 964, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 980 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 can implement any of a variety of types of data transfer technology, such as Single Carrier Radio Transmission Technology (1RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 916 are transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, in other example embodiments, the instructions 916 are transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine 900, and includes digital or analog communications signals or other intangible media to facilitate communication of such software.

Furthermore, the machine-readable medium 938 is non-transitory (in other words, not having any transitory signals) in that it does not embody a propagating signal. However, labeling the machine-readable medium 938 “non-transitory” should not be construed to mean that the medium 938 is incapable of movement; the medium 938 should be considered as being transportable from one physical location to another. Additionally, since the machine-readable medium 938 is tangible, the medium 938 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, by a server computer, a plurality of categories of data, wherein each category of the plurality of categories of data comprises at least one subcategory;
receiving, by the server computer, a weight associated with each subcategory of each category of the plurality of categories of data;
storing, by the server computer, the plurality of categories of data and associated subcategories and the weight associated with each subcategory of each category of the plurality of categories of data;
determining, by the server computer, that an activity occurring in a system has triggered a risk analysis;
determining, by the server computer, a user associated with the activity;
compiling, by the server computer, data related to the user associated with the activity;
analyzing, by the server computer, the data related to the user and determining one or more subcategories for the data;
analyzing, by the server computer, the one or more subcategories for the data and determining a risk rating for the user based on the weight of each of the one or more subcategories;
comparing, by the server computer, the risk rating to one or more predetermined threshold values to determine an alert value for the user; and
storing, by the server computer, the risk rating for the user, the alert value for the user, and the data related to the user.

2. The method of claim 1, further comprising:
receiving a rating associated with each subcategory; and
storing the rating associated with each subcategory.

3. The method of claim 1, further comprising:
receiving a response action associated with each subcategory; and
storing the response action associated with each subcategory.

4. The method of claim 1, wherein the activity occurring in the system that triggered the risk analysis is at least one of a group comprising: a registration request, a change in a company name associated with the user, a new account added by the user, a change in an address associated with the user, a transaction amount over a predetermined threshold, an addition of a new user associated with the user, a predetermined data that a risk analysis be periodically run, and a request to run a risk analysis.

5. The method of claim 1, wherein determining a risk rating for the user based on the weight of each of the one or more subcategories comprises:
calculating a total amount of the weights of each of the one or more subcategories.

6. The method of claim 1, further comprising:
providing, by the server computer, the risk rating and the alert value.

7. The method of claim 6, further comprising:
determining, based on a first predetermined threshold value, that the alert value is low, and based on the alert value, taking no further action for the activity associated with the user.

8. The method of claim 6, further comprising,
determining, based on a second predetermined threshold value, that the alert value is moderate, and based on the alert value, providing an alert indicating a review of the data related to the user is recommended.

9. The method of claim 6, further comprising:
determining, based on a third predetermined threshold value, that the alert value indicates that an account associated with the user be closed, and based on the alert value, providing an alert indicating that the account associated with the user was closed.

10. The method of claim 1, wherein the user is an individual or a business entity.

11. The method of claim 1, wherein data associated with a user comprises at least one of a group comprising: an amount of high-value assets, a type of high-value asset, access to funds, geographic risk, business validity, business stability, type of industry, risk of industry, business shell or shelf, business structure type, business age range, business match level, business legal activity, business news profile, business news profile type, linked businesses, executive officer data, contact information, criminal activity, driving records, and credit scores.

12. The method of claim 1, wherein compiling data related to the user associated with the activity comprises:
sending a request for data related to the user to one or more third party information providers;
receiving a response with third party data related to the user from the one more third party information providers;
accessing internal data related to the user from one or more databases; and
combining the third party data and the internal data.

13. A server computer comprising:
a processor; and
a computer-readable medium coupled with the processor, the computer-readable medium comprising instructions stored thereon that are executable by the processor to cause a computing device to perform operations comprising:
receiving a plurality of categories of data, wherein each category of the plurality of categories of data comprises at least one subcategory;
receiving a weight associated with each subcategory of each category of the plurality of categories of data;
storing the plurality of categories of data and associated subcategories and the weight associated with each subcategory of each category of the plurality of categories of data;
determining that an activity occurring in a system has triggered a risk analysis;
determining a user associated with the activity;
compiling data related to the user associated with the activity;
analyzing the data related to the user and determining one or more subcategories for the data;
analyzing the one or more subcategories for the data and determining a risk rating for the user based on the weight of each of the one or more subcategories;
comparing the risk rating to one or more predetermined threshold values to determine an alert value for the user; and
storing the risk rating for the user, the alert value for the user, and the data related to the user.

14. The server computer of claim 13, wherein determining a risk rating for the user based on the weight of each of the one or more subcategories comprises:
calculating a total amount of the weights of each of the one or more subcategories.

15. The server computer of claim 13, further comprising:
providing the risk rating and the alert value.

16. The server computer of claim 13, further comprising:
determining, based on a first predetermined threshold value, that the alert value is low, and based on the alert value, taking no further action for the activity associated with the user.

17. The method of claim 13, further comprising,
determining, based on a second predetermined threshold value, that the alert value is moderate, and based on the alert value, providing an alert indicating a review of the data related to the user is recommended.

18. The method of claim 13, further comprising:
determining, based on a third predetermined threshold value, that the alert value indicates that an account associated with the user be closed, and based on the alert value, providing an alert indicating that the account associated with the user was closed.

19. The method of claim 13, wherein compiling data related to the user associated with the activity comprises:
sending a request for data related to the user to one or more third party information providers;
receiving a response with third party data related to the user from the one or more third party information providers;
accessing internal data related to the user from one or more databases; and
combining the third party data and the internal data.

20. A computer-readable medium comprising instructions stored thereon that are executable by at least one processor to cause a computing device to perform operations comprising:
receiving a plurality of categories of data, wherein each category of the plurality of categories of data comprises at least one subcategory;
receiving a weight associated with each subcategory of each category of the plurality of categories of data;
storing the plurality of categories of data and associated subcategories and the weight associated with each subcategory of each category of the plurality of categories of data;
determining that an activity occurring in a system has triggered a risk analysis;
determining a user associated with the activity;
compiling data related to the user associated with the activity;
analyzing the data related to the user and determining one or more subcategories for the data;
analyzing the one or more subcategories of the data and determining a risk rating for the user based on the weight of each of the one or more subcategories;
comparing the risk rating to one or more predetermined threshold values to determine an alert value for the user; and
storing the risk rating for the user, the alert value for the user, and the data related to the user.
